(19) United States
(12) Patent Application Publication
(10) Pub. No.: US 2010/0093344 A1
(43) Pub. Date: Apr. 15, 2010

(54) MULTIPLEXING MSC/VLR SYSTEMS AND METHODS

(75) Inventors: Siu Bun Chan, Kowloontong (CN); Min Ying, Nanshan (CN); Hong Bin Liang, Nanshan (CN)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/250,804

(22) Filed: Oct. 14, 2008

(51) Int. Cl. H04W 4/00

(52) U.S. Cl. 455/433; 455/435.1; 455/422.1; 455/432.1

(57) ABSTRACT

In one embodiment, a wireless communication system provides wireless cellular service to wireless devices located within at least one coverage area associated with the wireless communication system. The wireless communication system comprising a register function to maintain information about the wireless devices that are located in the at least one coverage area, and a switching function to perform switching in connection with providing wireless cellular service to the wireless devices. The wireless communication system is connected to a plurality of first home public land mobile networks. The switching function and the register function are configured to function as an extension of each of the plurality of first home public land mobile networks when providing wireless service to wireless devices that are associated with the respective first home public land mobile network.

### BACKGROUND

Currently, there are over 700 Global System for Mobile communication (GSM) operators worldwide. Nearly all of these operators are tied to particular territories. That is, the operators have the right to use a particular portion of the GSM spectrum within given geographic territories. A GSM public land mobile network (PLMN) is a network established and operated by a recognized operating agency (ROA) for providing land GSM mobile telecommunications services to the public within a given geographic area (for example, within a given country). Each PLMN typically includes three major subsystems—a network switching subsystem (NSS) that carries out switching functions and manages the communications between wireless device and other upstream networks (for example, the Public Switched Telephone Network (PSTN) and/or other PLMNs), a base station subsystem (BSS) that handles traffic and signaling between wireless devices and the NSS, and an operation support subsystem (OSS) that carries out operation and maintenance functions in the PLMN. As used herein, a “home” PLMN (HPLMN) refers to the PLMN for which a given subscriber is a local subscriber. A “domestic” HPLMN refers to a HPLMN that provides wireless service to wireless devices that are located in a given country. Typically, there is more than one domestic HPLMN for each country.

However, there are some geographic regions that are typically not provided wireless service by any domestic HPLMN. Such areas include areas that are technically outside of the particular geographic area for which the domestic HPLMNs are licensed to provide wireless service (including, for example, extreme areas such as on ships at sea or on airplanes in flight) and areas that are technically inside of the particular geographic area for which the domestic HPLMNs are licensed to provide wireless service but that may be of lesser commercial interest.

There is a growing expectation on the part of wireless users for wireless service in many of these underserved areas. Thus, there are opportunities for small operators to provide wireless service in these areas. Typically, such small operators use low-cost or innovative techniques and systems to provide service in these underserved areas.

One way a small operator could provide wireless service in a historically underserved area is to deploy a small, full PLMN to provide wireless service in the underserved area. With such an approach, the small operator would typically need to negotiate and enter into roaming agreements with other PLMNs in order for the small operator to provide wireless service to subscribers of the other PLMNs as “roamers”. However, some small operators may not wish to devote the resources to negotiating and entering into roaming agreements with other PLMNs or such other PLMNs may not be willing to enter into roaming agreements with such small operators. Also, the small operator may wish to avoid devoting the resources necessary to implement and support the technical and administrative requirements called for by such roaming agreements (including, for example, passing roaming interoperability tests (IOT)). Moreover, the process of negotiating and entering into such roaming agreements and implementing and supporting the technical and administrative requirements called for by such roaming agreements typically has a long lead time.

Another way in which a small operator could provide wireless service in such a historically underserved area is to provide wireless service as an extension to a single domestic HPLMN. To do this, the small operator would deploy and operate a regional switching system that includes a mobile switching center (MSC), visitor location register (VLR), and a BSS. The small operator would not, however, deploy the central subscriber subsystem of a PLMN (for example, a home location register (HLR), an authentication center (AUC), and a prepaid service (PPS) server) but would instead use the central subscriber subsystem of the PLMN that is being extended. Such an approach is straightforward to implement, would require less resources to implement, and could be deployed in a relatively short amount of time. Because the small operator is an extension of the domestic HPLMN, the small operator is able to provide service to international roamers under the roaming agreements entered into by the domestic HPLMN, which eliminates the need for the small operator itself to enter into such roaming agreements.

However, as noted above, most countries have multiple domestic HPLMNs. Most domestic HPLMNs do not permit their subscribers to roam onto other domestic HPLMNs. This is because the coverage areas for all of the domestic HPLMNs will typically be substantially the same within that country, and in most situations there should be no reason for a subscriber of a domestic HPLMN to roam onto another domestic HPLMN. As a result, if such a small operator provides wireless service to an underserved area as an extension to a single domestic HPLMN, the small operator will typically not be able to provide service to subscribers of the other domestic HPLMNs.

### SUMMARY

In one embodiment, a wireless communication system provides wireless cellular service to wireless devices located within at least one coverage area associated with the wireless communication system. The wireless communication system comprising a register function to maintain information about the wireless devices that are located in the at least one coverage area, and a switching function to perform switching in connection with providing wireless cellular service to the wireless devices. The wireless communication system is connected to a plurality of first home public land mobile networks. The switching function and the register function are configured to function as an extension of each of the plurality of first home public land mobile networks when providing wireless service to wireless devices that are associated with the respective first home public land mobile network.

Another embodiment is a method for providing wireless cellular service to wireless devices located within a coverage area associated with a local wireless network. The method comprising providing wireless cellular service as an extension of each of a plurality of first public land mobile networks. The method further comprises, in connection with providing wireless cellular service as an extension of each of the plurality of first public land mobile networks, determining if a wireless device located within a coverage area is associated with a subscriber that one of the plurality of first public land mobile networks is configured to provide wireless cellular service to and, if the wireless device located within the coverage area is associated with a subscriber that one of the plurality of first public land mobile networks is configured to provide wireless cellular service to, providing wireless cellular service to the wireless device as an extension of that first public land mobile network.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a wireless communication system.

FIG. 2 is a flow diagram of one embodiment of a method of providing wireless service.

FIG. 3 is a flow diagram of one embodiment of a method of providing wireless service as an extension of another PLMN.

FIG. 4 is a block diagram of one exemplary implementation of the functionality described in connection with FIGS. 1-3.

FIG. 5 is a block diagram of another embodiment of a wireless communication system.

Like reference numbers and designations in the various drawings indicate like elements.

### DETAILED DESCRIPTION

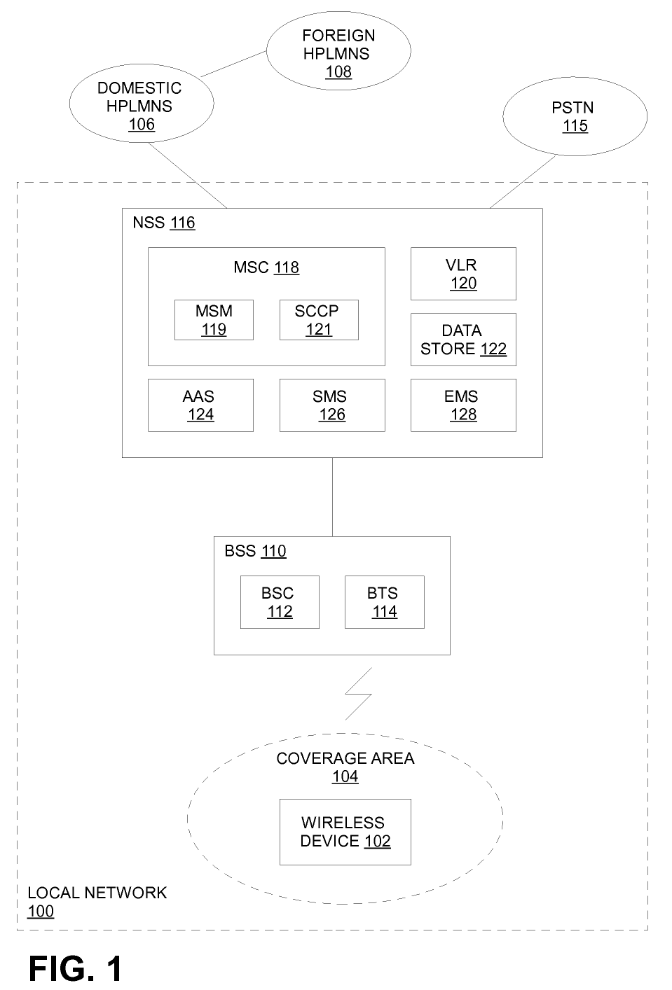

FIG. 1 is a block diagram of one embodiment of a wireless communication system 100 for providing wireless service to wireless devices 102 that are located within one or more coverage areas 104 that are associated with the system 100. The wireless communication system 100 is also referred to here as the “local” wireless communication system 100 or “local” system 100. The local system 100 is implemented as a wireless communication network and is also referred to here as the wireless communication network 100 or local network 100. The particular wireless communication system 100 shown in FIG. 1 is described here as being implemented in order to support one or more of the Global System for Mobile communication (GSM) family of telephony and data specifications and standards in order to provide wireless cellular service. It is to be understood, however, that other embodiments are implemented to support other wireless specifications or standards including, for example, one or more of the CDMA family of telephony and data standards (including, for example, the IS-95, CDMA2000, and EV-DO standards).

The system 100 comprises at least one base station subsystem (BSS) 110. The base station subsystem 110 implements at least one air interface that enables it to communicate with at least one wireless device 102 located within a coverage area 104 associated with the base station subsystem 110. In the particular embodiment shown in FIG. 1, the wireless device 102 is a GSM mobile station (such as a mobile telephone or a personal digital assistant) that is at least able to make and receive telephone calls. In this embodiment, the BSS 110 supports at least one GSM telephony air interface that enables the BSS 110 (and the wireless communication system 100) to communicate with a wireless device 102 that is able to make and receive telephone calls.

The BSS 110 comprises base station controller (BSC) functionality 112 and base transceiver station (BTS) functionality 114. In the particular embodiment shown in FIG. 1, the BSC functionality 112 implements GSM base station controller functions including, for example, base station management (including radio channel allocation, call handovers among base stations, and base transceiver station configuration), software and alarm handling, and operations and maintenance support. Moreover, in some embodiments, the BSC functionality 112 includes or is communicatively coupled to an appropriate network element or function (for example, a packet control unit (PCU)) for directing traffic to and from a data network (for example, the Internet or another data network that is coupled to the Internet).

The particular embodiment shown in FIG. 1 supports at least one GSM air telephony interface. The BTS functionality 114 implements GSM base station functionality including, for example, one or more radio transceivers (TRXs), power amplifiers, combiners, duplexers, and antennas (and/or suitable interfaces to connect the BTS functionality 114 to one or more antennas). In some embodiments, the base station subsystem 110 further includes transcoding functionality. In other embodiments, transcoding occurs elsewhere in the wireless communication system 100.

In some embodiments, the BSC functionality 112 and the BTS functionality 114 are implemented in separate devices that communicate with one another using the GSM Abis interface over suitable communication links. In some implementations of such embodiments, the communication links comprise one or more time division multiplexing (TDM) communication links such as E1 or T1 communication links or comprise a wide or local area network such as an Internet Protocol (IP) network. In other embodiments, at least a part of the BSC functionality 112 is implemented in the same device in which the BTS functionality 114 is implemented.

Although only a single BSS 110 and a single coverage area 104 are shown in FIG. 1, it is to be understood that the wireless communication system 100 can include any number of base station subsystems 110 and each base station subsystem 110 can include multiple coverage areas.

The wireless communication system 100 also comprises a network switching subsystem (NSS) 116. The NSS 116 is communicatively coupled to the base station subsystem 110. For example, in some embodiments, the NSS 116 is communicatively coupled to the base station subsystem 110 via one or more time division multiplexing (TDM) communication links such as E1 or T1 links. In other embodiments, the NSS 116 is communicatively coupled to the base station subsystem 110 via a wide or local area network such as an IP network. In other embodiments, the NSS 116 is communicatively coupled to the BSS 110 in other ways (for example, using wireless links such as satellite or microwave links or by integrating the NSS 116 (or portions thereof) and BSS 110 (or portions thereof) into the same device).

In the embodiment shown in FIG. 1, the NSS 116 comprises a mobile switching center (MSC) 118 to implement GSM MSC functionality. The MSC 118 performs call processing and switching and mobility and handover handling. In the particular embodiment shown in FIG. 1, the MSC 118 comprises a Mobile Signaling Multiplexer (MSM) 119 for performing call switching and a Signaling Connection Control Part (SCCP) function 121 for performing the SCCP processing described below. The MSM 119 implements standard Service Switching Function (SSF) entity functionality as well as the special multiplexing functionality described below for providing wireless service to domestic subscribers of the plurality of domestics HPLMNs 106 as an MSC/VLR extension of the respective domestic HPLMN 106.

Also, in this particular embodiment, the MSC 118 communicates with each BSS 110 using the GSM A interface.

In the embodiment shown in FIG. 1, the NSS 116 also comprises a visitor location register (VLR) 120 that implements GSM visitor location register functionality. Each separate coverage area 104 that is supported by wireless communication system 100 has one VLR with which it is associated. The VLR 120 comprises a data store 122 in which information about each subscriber who is currently in a coverage area 104 that is associated with the VLR 120 is stored.

In the embodiment shown in FIG. 1, the NSS 116 further comprises an audio announcement server (AAS) 124 to provide audio announcements to users of the system 100, a short message service (SMS) server 126 to implement GSM short message service functionality, and an element management system (EMS) 128 to configure and manage the system 100.

In the particular embodiment shown in FIG. 1, the NSS 116 is also communicatively coupled to a public switched telephone network (PSTN) 115 (for example, for voice communications).

The local wireless network 100 is communicatively coupled to a plurality of PLMNs 106 for which the system 100 is able to act as a MSC/VLR extension in connection with providing wireless cellular service. In other words, for each such PLMN 106, the local wireless network 100 provides wireless cellular service to wireless devices 102 that are associated with that PLMN 106 as if the local wireless network 100 is a part of that PLMN 106. For example, subscribers of such a PLMN 106 are able to use the local wireless network 100 as if they were using the PLMN 106 itself. Also, the local wireless network 100 can leverage the roaming agreements that the PLMNs 106 have entered into with other PLMNs 108 to provide wireless service to subscribers of those other PLMNs 108.

In the embodiment shown in FIG. 1, the PLMNs 106 comprise all of the domestic HPLMNs 106 for a given country and the other PLMNs 108 comprise PLMNs for other countries (also referred to here as “international” PLMNs 108). Subscribers of the domestic HPLMNs 106 are also sometimes referred to here as “domestic” subscribers, and subscribers of the international PLMNs 108 are also sometimes referred to here as “international” subscribers or “roamers.”

The embodiment shown in FIG. 1 is configured to provide wireless service to domestic subscribers of the plurality of domestics HPLMNs 106 as an MSC/VLR extension of the respective domestic HPLMN 106. This would typically not be possible if the local wireless network 100 were implemented as an MSC/VLR extension of only one of the HPLMNs 106. This is because domestic HPLMNs 106 typically do not permit their subscribers to roam onto other domestic HPLMNs 106. The local wireless network 100 is also configured to provide wireless service to international subscribers as roamers on one of the domestic HPLMNs 106. As a result, embodiments of the local wireless network 100 are able to provide wireless service to domestic subscribers of all of the domestic HPLMNs 106 and are able to provide roaming service to those international subscribers of international HPLMNs 108 with which the domestic HPLMNs 106 have roaming agreements in place.

In this particular embodiment, the local wireless network 100 does not include a separate central subscriber subsystem for the local wireless network 100 (including, for example, a separate a home location register (HLR), authentication center (AUC), or prepaid service (PPS) server). Instead, the local wireless network 100 uses the central subscriber subsystems of the domestic HPLMNs 106 that are being extended by the wireless communication system 100. This approach typically requires less resources to implement, and typically can be deployed in a relatively short amount of time. However,

Because the wireless communication system 100 is an extension of the domestic HPLMNs 106, the operator of the wireless communication system 100 is able to provide service to international roamers under the roaming agreements entered into by the domestic HPLMNs 106, which eliminates the need for that operator to enter into its own roaming agreements. Also, if the wireless communication system 100 is functions as an extension of all of the domestic HPLMNs 106 for a given country (or other relevant territory), the operator of the wireless communication system 100 is able to provide service to all domestic subscribers as an extension of the respective domestic HPLMN 106).

As noted above, domestic HPLMNs 106 typically do not permit their subscribers to roam onto other domestic HPLMNs 106. One way domestic HPLMNs 106 enforce this restriction is enforced is by configuring the SIM modules they provide to their subscribers to prohibit each such SIM module (and wireless device it is used with) to be used with the other domestic HPLMs 106. Each such SIM module is hard-coded with the home network identifiers (HNI) of the other domestic HPLMNs 106, and the SIM module is configured to prohibit use with networks having those HNIs. As noted below, the HNI of a particular public land mobile network comprises the relevant mobile country code (MCC) and the network's mobile network code (MNC). In order to provide wireless service as an MSC/VLR extension of all of the plurality of domestic PLMNs 106, the local network 100 uses a HNI that is not the same as any HNI that is used by any of the domestic HPLMNs 106.

Also, in order to provide wireless service as an MSC/VLR extension of all of the plurality of PLMNs 106, the MSC 118 and the VLR 120 of the local wireless network 100 are configured so that the MSC 118 and VLR 120 function, from the perspective of each of the domestic HPLMNs 106, as if they were dedicated parts of each of the domestic HPLMNs 106. When the local wireless network 100 provides wireless service to a wireless devices 102 as an extension of one of the domestic HPLMNs 106, the various functions of the local wireless network 100 must be able to send messages that are compatible with the addressing and routing schemes used in the domestic HPLMN 106 and must be able to receive, process, and respond to messages received from nodes in the domestic HPLMN 106.

In the particular embodiment of the local wireless network 100 shown in FIG. 1, Signaling System 7 (SS7) is used for signaling. SS7 is a layered protocol. One part of the SS7 protocol that is relevant to the techniques described here is the Message Transfer Part (MTP), the highest level of which is Message Transfer Part Level 3. Message Transfer Part Level 3 is split into two distinct parts-Signaling Message Handling (SMH) and Signaling Network Management (SNM). The SNM part handles general management of MTP, and the SHM part handles the discrimination, distribution and routing of signaling messages.

MTP Level 3 provides routing capabilities based upon a numerical address referred to as a “point code”. Each point code uniquely identifies a particular node in a network and is used whenever it is necessary to address that signaling point. Point code addresses are assigned using a three-level hierarchy. Individual signaling points are identified as belonging to a cluster of signaling points. Within each cluster, each signaling point is assigned a member number. Similarly, a cluster is defined as being part of a network. Thus, the point code for each node in an SS7 network is a three-level number defined by its network, cluster, and member numbers. As used herein, an “originating point code” (OPC) identifies the sending signaling point for a given signaling message, and a “destination point code” (DPC) identifies the receiving signaling point for a given signaling message.

Such SS7 point code numbers or addresses are assigned on a nationwide basis by a neutral authority. Because such network numbers are a relatively scarce resource, operators' networks are expected to meet certain size requirements in order to be assigned a separate network number. Smaller networks will be assigned one or more cluster numbers within specific network numbers only.

The point codes of the SS7 nodes of all the network elements of an operator's network must be lay within the scope of the SS7 network number or cluster number assigned to that operator's network by the relevant authority. Different operators have different SS7 numbers. Since the local wireless network 100 of FIG. 1 (and the elements thereof) must act as network elements of multiple domestic HPLMNs 106, the local wireless network 100 supports multiple point code working schemes. That is, when the local wireless network 100 is functioning as an extension of a given domestic HPLMN 106, the local wireless network 100 must use an originating point code (OPC) that falls within the point code numbering scheme used by that domestic HPLMN 106. In one implementation of such an embodiment, the MSM 119 maintains a table that associates an appropriate OPC with each of the domestic HPLMNs 106 that the wireless local network 100 is able to function as an extension of.

Another part of the SS7 layer protocol that is relevant to the techniques described here is the Signaling Connection Control Part (SCCP). The SCCP provides two major functions that are lacking in the MTP. The first of these is the capability to address application service elements within a signaling point. The MTP can only receive and deliver messages for a limited number of user parts (for example, the ISDN User Part (ISUP) or the SCCP). The SCCP also has the ability to address specification applications (for example, MSC, VLR, or SSF applications) that are available on a particular node associated with a given DPC. A subsystem number (SSN) is used to address such applications.

The second function provided by the SCCP is the ability to perform distributed routing using a capability called global title translation (GTT). A “Global Title” (GT) is an address used for routing in an SS7 network. The GT can be used by, for example, the higher levels of SS7 such as the Signaling Connection Control Part and applications such as the MSC, VLR, or SSF. The use of a GT frees the originating signaling point from the burden of having to know every potential destination point code to which they might have to route a message. At some point, however, a destination point code must be determined for each message for use by the MTP. The SCCP employs a Global Title Translation to determine a destination point code from a GT so as to instruct the MTP on where to route each such message.

In order for the local wireless network 100 to operate as an extension of multiple domestic HPLMNs 106, the various elements of the local wireless network 100 must use global titles that fall within the respective addressing and routing scheme used in each of the domestic HPLMNs 106 when send signaling messages to elements of that domestic HPLMN 106 using global title routing. In one implementation of such an embodiment, the SCCP function 121 maintains a table that associates an appropriate GT with each relevant application (for example, HLR, gateway MSC, etc.) in each of the domestic HPLMNs 106. In such an implementation, each such GT/application association is keyed off of a local identifier associated with the respective domestic HPLMN 106.

Also, the local wireless network 100 must perform appropriate global title translation for signaling messages received from each of the domestic HPLMNs 106 that are to be routed using global title routing to elements of the local wireless network 100 (for example, that are to be routed to the various MSC 118, VLR 120, and MSM 119 applications of the local network 100). In one implementation of such an embodiment, the SCCP function 121 maintains a table that, for each of the domestic HPLMNs 106, associates a respective appropriate GT falling within the addressing scheme of that domestic HPLMN 106 with each relevant application (for example, VLR 120, MSC 118, MSM 119) of the local wireless network 100. When a message including such a GT is received from one of the domestic HPLMNs 106, such a table can be used by the SCCP 121 in performing global title translation to translate the GT to an appropriate SSN and DPC of the application that implements the intended application.

A Mobile Station Roaming Number is an E.164 defined telephone number used to route telephone calls in a mobile network to the target MSC. The MSRN is essentially an MSISDN telephone number at which a particular subscriber can currently be reached. The MSRN is a temporary, location-dependent number assigned to a subscriber by the VLR that handles the coverage area in which the subscriber is currently located. The assigned MSRN is valid only for the duration of a single call set up. When a call is to be setup with that subscriber, the HLR for the subscriber queries the subscriber's current VLR for a MSRN for the subscriber. The current VLR assigns a MSRN to the subscriber that is selected from a MSRN segment (that is, a range of MSRNs). The operator of an PLMN allocates to each VLR a MSRN segment from the MSISDN resources they have received from the relevant authority. As a consequence, when the local wireless network 100 is providing wireless service as an extension of a particular domestic HPLMN 106, the VLR 120 of the local wireless network 100 must be configured to assign MSRNs from an MSRN segment assigned by that domestic HPLMN 106 to that VLR 120.

A location area is a group of one or more base stations (that is, BTS 114) and the associated coverage areas. Each PLMN typically associates a particular code (referred to as a “location area code” (LAC)) with each of its location areas. When the local wireless network 100 is providing wireless service as an extension of a particular domestic HPLMN 106, the local wireless network 100 must be configured to use an appropriate LAC that falls within the LAC scheme used by that domestic HPLMN 106 when communicating with that domestic HPLMN 106 (for example, when generating call data records (CDRs) for that domestic HPLMN 106).

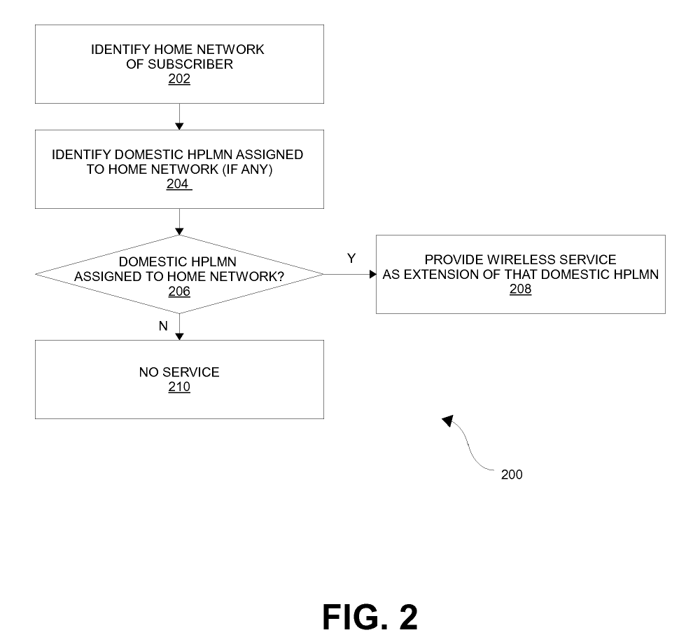

For each wireless device 102 in a coverage area 104 associated with the VLR 120, the VLR 120 determines if that wireless device 102 is to be provided wireless service as an extension of one of the domestic HPLMNs 106 and, if it is, identifies the particular domestic HPLMN 106 that wireless service is to be provided as an extension of. FIG. 2 is a flow diagram of one embodiment of a method 200 of making such determinations. The particular embodiment of method 200 shown in FIG. 2 is described here as being implemented using the wireless network 100 of FIG. 1. It is to be understood, however, that other embodiments are implemented in other ways.

Also, although method 200 is depicted in FIG. 2 with the processing of method 200 occurring in a particular order for ease of explanation, it is to be understood that the processing of method 200 can occur in a different order or with certain processing occurring in parallel. Moreover, it is to be understood that the processing shown in FIG. 2, when implemented in software, can be implemented using various software techniques and paradigms.

For each wireless device 102 that is in coverage area 104 of the local network 100, the VLR 120 identifies the home network for the subscriber associated with that wireless device 102 (block 202). In one implementation, the VLR 120 receives the subscriber's International Mobile Subscriber Identity (IMSI) number (which is stored in a SIM module used in that subscriber's wireless device 102) and identifies the identity of the subscriber's home network from the mobile country code (MCC) and mobile network code (MNC) of the received IMSI (which comprise the home network identity (HNI)).

The VLR 120 then identifies which (if any) of the domestic HPLMNs 106 the local network 100 is assigned to the identified home network (block 204). In one implementation, the SCCP function 121 maintains a table that maps each of various home network identifiers to one of the domestic HPLMNs 106 that the local wireless network 100 is able to act as an extension of. Each of the domestic HPLMNs 106 is mapped to itself. Each of the foreign HPLMNs 108 is mapped to a respective one of the domestic HPLNs 106 that is able to provide roaming service to subscribers of that foreign HPLMN 108. In such an implementation, the table maintained by the SCCP function 121 maps IMSI numbers (specifically, the HNI) or MSIDIN numbers (specifically, the portion that identifies the home network of the associated subscriber) to a network indictor that is associated with one of the domestic HPLMNs 106 that the local network 100 is able to act as an extension of. The network indicator is used locally by the local wireless network 100 (for example, where the local network 100 is able to act as an extension of eight domestic HPLMNs 106, the network indicators can be 0, 1, . . . 7).

In situations where more than one of the domestic HPLMNs 106 is able to provide roaming service for subscribers of a particular foreign HPLMN 108, a predetermined selection policy can be used to determine which domestic HPLMN 106 should be used to provide roaming service to subscribers of that foreign HPLMN 108. For example, in some implementations, one of the domestic HPLMNs 106 is pre-assigned to each foreign HPLMN 108 (that is, such assignments are static). In other implementations, the domestic HPLMNs 106 are dynamically assigned to the foreign HPLMNs 108 (for example, on a round robin basis). In some implementations, some of the foreign HPLMNs 108 have a respective domestic HPLMN 106 statically assigned to them while the other foreign HPLMNs 108 have a respective domestic HPLMN 106 dynamically assigned to them.

If there is a domestic HPLMN 106 assigned to the identified home network (checked in block 206), the local wireless network 100 provides wireless service to the wireless device 102 (and the associated subscriber) as an extension of that domestic HPLMN 106 (block 208). If there is no domestic HPLMN 106 assigned to the identified home network, the local wireless network 100 does not provide wireless service to the wireless device 102 (and the associated subscriber) (block 210).

In the implementation described above, if the table maintained by the SCCP function 121 maps the identified home network identifier to one of the domestic HPLMNs 106, the local wireless network 100 provides wireless service to that wireless device 102 (and the associated subscriber) as an extension of that domestic HPLMN 106. In the implementation described above, if the table maintained by the SCCP function 121 does not map a particular home network identifier to one of the domestic HPLMNs 106, the local wireless network 100 is not able to provide wireless service to that subscriber using conventional roaming techniques.

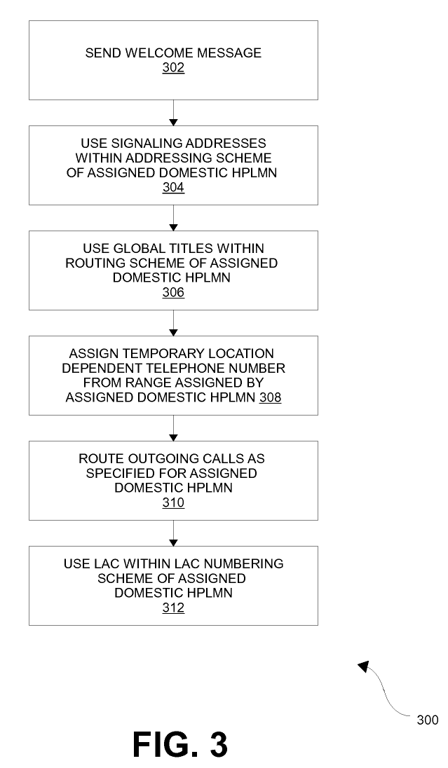

FIG. 3 is a flow diagram of one exemplary method 300 of providing wireless service as an extension of one of the domestic HPLMNs 106. The particular embodiment of method 300 shown in FIG. 3 is described here as being implemented using the wireless network 100 of FIG. 1. More specifically, the embodiment of method 300 shown in FIG. 3 is one implementation of the processing from method 200 that is described above in connection with block 208 of FIG. 2. It is to be understood, however, that other embodiments are implemented in other ways.

Also, although method 300 is depicted in FIG. 3 with the processing of method 300 occurring in a particular order for ease of explanation, it is to be understood that the processing of method 300 can occur in a different order or with certain processing occurring in parallel. Moreover, it is to be understood that the processing shown in FIG. 3, when implemented in software, can be implemented using various software techniques and paradigms.

As noted above, the embodiment of method 300 shown in FIG. 3 is one implementation of the portion of method 200 described above in connection with block 204 of FIG. 2. This embodiment of method 300 is performed when a wireless device 102 that is a coverage area 104 associated with the VLR 120 is a subscriber of a home network that is assigned to one of the domestic HPLMNs 106. In the context of FIG. 3, the domestic HPLMN 106 that is assigned to the home network of the wireless device 102 (and associated subscriber) is referred to here as the “assigned” domestic HPLMN 106.

When a wireless device 102 enters a coverage area 104 associated with the local wireless network 100 and registers with the network 100, a SMS “welcome” message is sent to the wireless device (block 302). Such a SMS welcome message may include, for example, information indicating that the subscriber is being provided service through the local service provider as a “premium” service. The format of the SMS function, in one implementation, can be customized for each of the domestic HPLMNs 106 that the local wireless network 100 acts as an extension of.

In connection with providing wireless service as an extension of the assigned domestic HPLMN 106, the local wireless network 100 (and the various functions implemented therein) uses one or more signaling addresses that fall within the addressing scheme used in the assigned domestic HPLMN 106 for one or more signaling points that are contained in the local wireless network 100 (block 304). More specifically, in the GSM embodiment described here, the one or more signaling points that implement the various functions (for example, MSC 118, VLR 120, and MSM 119) have an associated SS7 point code that falls within the particular SS7 point code numbering scheme that is used by the assigned domestic HPLMN 106. Where the various functions of the local wireless network 100 are implemented on a single signaling point, one such point code is used and the MSM 119 maps each domestic HPLMN 106 to an appropriate SS7 point code for that signal point that falls within the SS7 point code numbering scheme of that domestic HPLMN 106. In one implementation of such an embodiment, this mapping is implemented by extending the MTP3 linkset information that the MSM 119 maintains for each MTP3 linkset used by the local wireless network 100. The MTP3 linkset information is extended to include an OPC that should be used when sending signaling messages via a particular MTP3 linkset. That is, when the VLR 120 (or other function of the local wireless network 100) sends a signaling message to a signaling point within the assigned domestic HPLMN 106, the particular OPC mapped to that assigned domestic HPLMN 106 is used in that signaling message.

In connection with providing wireless service as an extension of the assigned domestic HPLMN 106, the local wireless network 100 also uses global titles falling within the addressing scheme of the assigned domestic HPLMN 106 (block 306). More specifically, in the GSM embodiment described here, the SCCP function 121 implements the SCCP processing for the local wireless network 100 including, for example, processing for signaling messages received from the assigned domestic HPLMN 106 and processing for signaling messages sent from functions in the local wireless network 100 to functions within the assigned domestic HPLMN 106. As noted above, the SCCP function 121 maps each of the various home networks of the various subscribers to one of the domestic HPLMNs 106 that the local wireless network 100 is able to act as an extension of.

In such an embodiment, the SCCP function 121 is also able to identify the appropriate global title for each subsystem (that is, MSC, VLR, SSF) of each of the domestic HPLMNs 106 that the local network 100 is able to act as an extension of. In one implementation of such an embodiment, the SCCP function 121 maintains a table for each subsystem function that maps the network indicator for each of the domestic HPLMNs 106 to an appropriate global title for that subsystem function of that domestic HPLMN 106. In this way, when a signaling message needs to be sent from the local network 100 to the MSC of a particular domestic HPLMN 106 that local network 100 is acting as an extension of, the SCCP function 121 identifies the network indicator for that message by using, for example, the HNI of the IMSI of the corresponding wireless device to lookup the network indicator in the table noted above in connection with FIG. 2. The SCCP function 121 then uses the network indicator to look up the global title of the MSC of that particular domestic HPLMN 106 in the subsystem function table noted above that is maintained for the MSC function.

In connection with providing wireless service as an extension of the assigned domestic HPLMN 106, the local wireless network 100 assigns a temporary location dependent telephone number from a range of such telephone numbers allocated to the local network 100 by the assigned domestic HPLMN 106 (block 308). More specifically, in the GSM embodiment described here, each domestic HPLMN 106 assigns a range of mobile station roaming numbers to the local wireless network 100. The VLR 120 allocates a mobile station roaming number (MSRN) for each wireless device 102 that is being provided wireless service as an extension of a particular domestic HPLMN 106 from the MSRN range assigned to the local network 100 by that domestic HPLMN 106. In one implementation, the VLR 120 maintains a table that identifies the MSRN range for each of the domestic HPLMNs 106 that the local wireless network 100 provides wireless service as an extension of.

In connection with providing wireless service as an extension of the assigned domestic HPLMN 106, outgoing calls that are made by such a wireless device 102 are routed by the MSC 118 in the manner specified for the assigned domestic HPLMN 106 (block 3 10). In some embodiments, the local wireless network 100 supports multiple outgoing call routing schemes, where each domestic HPLMN 106 that the local wireless network 100 acts as an extension of can have its own call outgoing routing scheme. That is, in such embodiment, the outgoing call routing scheme can be configured on per HPLMN basis. For example, outgoing calls can be routed through the local link to the PSTN 115 (or other local network connection) or routed back through the domestic HPLMN 106. In other embodiments, all calls are routed through the local connection to the PSTN 115.

When the local wireless network 100 is providing wireless service to a wireless device 102 located within a coverage area 104 associated with the local wireless network 100 as an extension of the assigned domestic HPLMNs 106, the local wireless network 100 uses a location area code that falls within the LAC numbering scheme of the assigned domestic HPLMN 106 (block 312). In one implementation of such an embodiment, the MSC 118 maintains a table that identifies for each of the domestic HPLMNs 106 the appropriate LAC to be used for each of the local network's location areas. The LAC is used, for example, in generating CDRs. The local wireless network 100 provides CDRs to each of the domestic HPLMNs 106 that it acts as an extension of. In one implementation, this is done by filtering and sorting the various CDRs based on the domestic HPLMN 106 (using, for example, the IMSI field) that the local network 100 was acting as an extension of when service was provided for the associated call. For example, CDRs that are related to providing service to domestic subscribers are provided to the domestic HPLMN 106 associated with each such domestic subscriber, and CDRs that are related to providing roaming service to foreign subscribers are provided to the domestic HPLMN 106 that the local network 100 was acting as an extension of in connection with providing the associated roaming service to each such foreign subscriber. This function can be carried out, for example, by the EMS 128. In some implementations, this is done on a near real time basis.

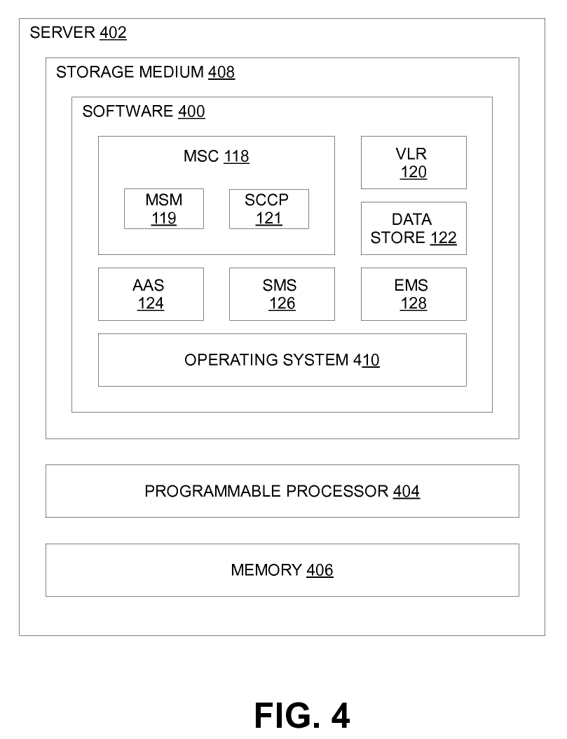

The functionality described above can be implemented in various ways. FIG. 4 is a block diagram of one exemplary implementation of such functionality. In the exemplary implementation shown in FIG. 4, the NSS 116 functionality described above is implemented as software 400 that executes on a server 402. The server 402 comprises one or more programmable processors 404 for executing the software 400 and memory 406 for storing the program instructions and any related data. The software 400 comprises program instructions that are stored (or otherwise embodied) on an appropriate storage medium or media 408 (such as flash memory) from which at least a portion of the program instructions are read by the programmable processor 404 for execution thereby.

The server 402 includes one or more appropriate interfaces 410 to communicatively couple the server 402 to other elements of the local system 100 (for example, one or more BSSs 110 (if the BSS functionality is not implemented in the server 402)), the PSTN 115, and/or the domestic HPLMNs 106.

The software 400 implements the functionality for one or more of the MSC 118, the MSM 119, the SCCP function 121, the VLR 120, VLR data store 122, the AAS 124, the SMS server 126, and the EMS 128. In the particular embodiment shown in FIG. 4, the software 400 also comprises an operating system 412 that controls the execution of the rest of the software 400.

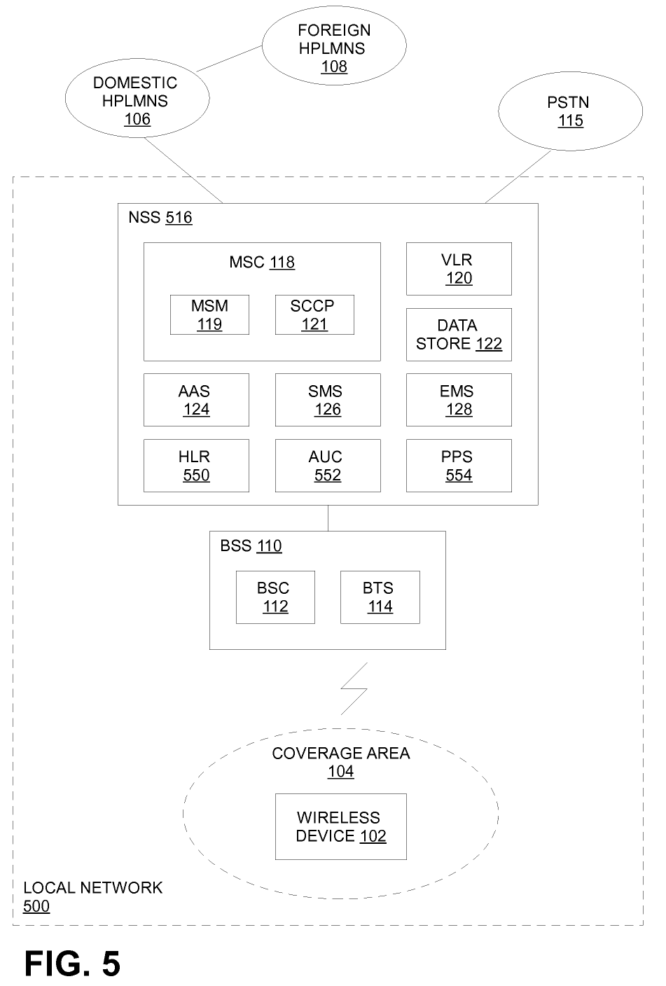

In the embodiments described above in connection with FIGS. 1-4, the local network 100 does not have any subscribers of its own. In other embodiments, the local network 100 does have subscribers of its. FIG. 5 is a block diagram of one embodiment of a local network 500. The local network 500 of FIG. 5 is the same as the embodiment of local network 100 of FIG. 1 except as described below. Those parts of local network 500 that are the same as the corresponding parts of local network 100 are referenced in FIG. 5 using the same reference numerals as used in FIG. 1 and the description of such parts is not repeated here.

Because the local network 500 has subscribers of its own, the local network 500 at least some central subscriber functionality. In the particular embodiment shown in FIG. 5, the NSS 116 further includes a home location register (HLR) 550 for the local network 500 that implements GSM home location register functionality. The HLR 550 comprises a data store in which information about each local subscriber of the local network 500 is stored. Typically, there is one logical HLR per PLMN, although the HLR may be implemented using multiple physical HLRs.

In the embodiment shown in FIG. 5, the NSS 116 also comprises an authentication center (AUC) 552 that implements GSM authentication functionality. The AUC 552 is used to authorize local subscribers of the local network 500. In some embodiments, the AUC 552 is integrated with the HLR 550.

In the embodiment shown in FIG. 5, the NSS 516 also comprises a prepaid server (PPS) 554 to implement standard GSM prepaid functionality. The PPS 554 includes or is coupled to a data store to store prepaid-related information.

In such an embodiment, the VLR 120 determines if a subscriber associated with a particular wireless device 102 is a local subscriber of the local network 500. If the subscriber is a local subscriber, the local network 500 provides wireless cellular service to that subscriber and wireless device in the conventional manner. If the subscriber is not a local subscriber, the techniques described above in connection with FIGS. 1-4 are used to provide wireless service to that subscriber. The determination as to whether a particular subscriber is a local subscriber is made based on the IMSI (in particular, the HNI).

In one application of the embodiment shown in FIG. 5, the local subscriber functionality of the local network 500 is used to implement a private cellular network within the particular coverage area associated with the local network 500 for the local subscribers while the functionality described above in connection with FIGS. 1-4 is used to provide public cellular service to other subscribers.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A wireless communication system for providing wireless cellular service to wireless devices located within at least one coverage area associated with the wireless communication system, the wireless communication system comprising:
a register function to maintain information about the wireless devices that are located in the at least one coverage area; and
a switching function to perform switching in connection with providing wireless cellular service to the wireless devices;
wherein the wireless communication system is connected to a plurality of first home public land mobile networks; and
wherein the switching function and the register function are configured to function as an extension of each of the plurality of first home public land mobile networks when providing wireless service to wireless devices that are associated with the respective first home public land mobile network.

2. The wireless communication system of claim 1, wherein a wireless device is considered to be associated with a respective one of the plurality of first home public land mobile networks if the wireless device is associated with a subscriber of the respective first home public land mobile network or a subscriber of a public land mobile network that has a roaming agreement with the respective first home public land mobile network.

3. The wireless communication system of claim 1, wherein the switching function and the register function are configured to provide wireless service to wireless devices associated with a plurality of second home public land mobile networks, each of the plurality of second home public land mobile networks having a roaming agreement with at least one of the plurality of first home public land mobile networks; and
wherein the switching function and the register function are configured to function, when providing wireless service to wireless devices that are associated with each of the plurality of second home public land mobile networks, as an extension of a respective one of the plurality of first home public land mobile networks with which the respective second home public land mobile network has a roaming agreement.

4. The wireless communication system of claim 1, wherein the register function is configured to determine if a first wireless device that is located within the coverage area associated with the wireless communication system is associated with a subscriber of one of the plurality of first home public land mobile networks and, if the first wireless device is associated with a subscriber of one of the plurality of first home public land mobile networks, the wireless communication system provides wireless service to the first wireless device as an extension of that first home public land mobile network.

5. The wireless communication system of claim 1, further comprising a network switching subsystem comprising visitor location register (VLR) that includes the register function and a mobile switching center (MSC) that includes the switching function.

6. The wireless communication system of claim 1, wherein the wireless communication system is configured to send a welcome message to each wireless device that the wireless communication system is providing wireless service to as an extension of one of the plurality of first home public land mobile networks.

7. The wireless communication system of claim 1, wherein the wireless communication system is configured to, when providing wireless service as an extension of each of the plurality of first home public land mobile networks, use signaling addresses within a respective addressing scheme used in the respective first home public land mobile network.

8. The wireless communication system of claim 7, wherein the signaling addresses comprise Signaling System 7 (SS7) point codes.

9. The wireless communication system of claim 1, wherein the wireless communication system is configured to, when providing wireless service as an extension of each of the plurality of first home public land mobile networks, use global titles within a respective routing scheme used in the respective first home public land mobile network.

10. The wireless communication system of claim 9, further comprising a Signaling Connection Control Part (SCCP) function to perform global title translation using global titles within the respective routing scheme used in a respective first home public land mobile network when the wireless communication system is providing wireless service as an extension of the respective first home public land mobile network.

11. The wireless communication system of claim 10, wherein the SCCP function is operable to identify appropriate respective global titles for respective subsystem functions of each of the plurality of first home public land mobile networks.

12. The wireless communication system of claim 1, wherein the wireless communication system is configured to, when providing wireless service as an extension of each of the plurality of first home public land mobile networks, allocates temporary, location-dependent telephone numbers from a respective range assigned by the respective first home public land mobile network to the wireless communication system.

13. The wireless communication system of claim 12, wherein the temporary, location-dependent telephone numbers comprise GSM mobile station roaming numbers (MSRNs).

14. The wireless communication system of claim 1, wherein the wireless communication system is configured to, when providing wireless service as an extension of each of the plurality of first home public land mobile networks, route outgoing calls as specified for the respective home public land mobile network.

15. The wireless communication system of claim 1, wherein the wireless communication system is configured to, when providing wireless service as an extension of each of the plurality of first home public land mobile networks, use location area codes within the location area code numbering scheme of the respective home public land mobile network.

16. The wireless system of claim 1, further comprising at least one of a home location register, an authentication center, and a prepaid service server, wherein the wireless system has local subscribers thereof.

17. A method for providing wireless cellular service to wireless devices located within a coverage area associated with a local wireless network, the method comprising:
providing wireless cellular service as an extension of each of a plurality of first public land mobile networks;
in connection with providing wireless cellular service as an extension of each of the plurality of first public land mobile networks:
determining if a wireless device located within a coverage area is associated with a subscriber that one of the plurality of first public land mobile networks is configured to provide wireless cellular service to; and
if the wireless device located within the coverage area is associated with a subscriber that one of the plurality of first public land mobile networks is configured to provide wireless cellular service to, providing wireless cellular service to the wireless device as an extension of that first public land mobile network.

18. The method of claim 17, wherein if the wireless device located within the coverage area is associated with a subscriber of one of the plurality of first public land mobile networks, providing wireless cellular service to the wireless device as an extension of that first public land mobile network.

19. The method of claim 17, wherein if the wireless device located within the coverage area is associated with a subscriber of a second public land mobile network that has a roaming agreement with one of the plurality of first public land mobile networks, providing wireless cellular roaming service to the wireless device as an extension of that first public land mobile network under the roaming agreement.

20. The method of claim 17, wherein providing wireless cellular service as an extension of each of the plurality of first public land mobile networks comprises providing wireless cellular service as a mobile switching center (MSC)/visitor location register (VLR) extension of each of the plurality of first public land mobile networks.

21. The method of claim 17, further comprising sending a welcome message to each wireless device that the wireless communication system is providing wireless cellular service to as an extension of one of the plurality of first public land mobile networks.

22. The method of claim 17, further comprising, in connection with providing wireless cellular service as an extension of each of the plurality of first public land mobile networks, using signaling addresses within a respective addressing scheme used in the respective first public land mobile network.

23. The method of claim 17, further comprising, in connection with providing wireless cellular service as an extension of each of the plurality of first public land mobile networks, using global titles within a respective routing scheme used in the respective first public land mobile network.

24. The method of claim 17, further comprising, in connection with providing wireless cellular service as an extension of each of the plurality of first public land mobile networks, allocating mobile station roaming numbers from a respective range assigned by the respective first public land mobile network..

25. The method of claim 17, further comprising, in connection with providing wireless cellular service as an extension of each of the plurality of first public land mobile networks, route outgoing calls as specified for the respective public land mobile network.

26. The method of claim 17, further comprising, in connection with providing wireless cellular service as an extension of each of the plurality of first public land mobile networks, using location area codes within the location area code numbering scheme of the respective home public land mobile network.

27. The method of claim 17, further providing wireless cellular service to local subscribers of the local wireless network.

28. A program product comprising a processor-readable medium on which program instructions are embodied, wherein the program instructions are operable, when executed by at least one programmable processor included in a device, to cause the device to:
provide wireless service as an extension of each of a plurality of first public land mobile networks;
in connection with providing wireless service as an extension of each of the plurality of first public land mobile networks:
determining if a wireless device located within a coverage area is associated with a subscriber that one of the plurality of first public land mobile networks is configured to provide wireless service to; and
if the wireless device located within the coverage area is associated with a subscriber that one of the plurality of first public land mobile networks is configured to provide wireless service to, providing wireless service to the wireless device as an extension of that first public land mobile network.

29. A system comprising:
at least one programmable processor;
at least one interface to connect the system to a plurality of first public land mobile networks;
wherein the programmable processor is configured to execute software that is operable to cause the system to:
provide wireless service as an extension of each of the plurality of first public land mobile networks;
in connection with providing wireless service as an extension of each of the plurality of first public land mobile networks:
determine if a wireless device located within a coverage area associated with the system is associated with a subscriber that one of the plurality of first public land mobile networks is configured to provide wireless service to; and
if the wireless device located within the coverage area associated with the system is associated with a subscriber that one of the plurality of first public land mobile networks is configured to provide wireless service to, provide wireless service to the wireless device as an extension of that first public land mobile network.

30. A wireless system comprising:
a base station subsystem to communicate with at least one wireless device located within a coverage area associated with the wireless system; and
a network switching subsystem communicatively coupled to the base station subsystem, the network switching subsystem comprising:
a register function to maintain information about the wireless devices that are located in the at least one coverage area; and
a switching function to perform switching in connection with providing wireless cellular service to the wireless devices;
wherein the wireless system is connected to a plurality of first public land mobile networks; and
wherein the switching function and the register function are configured to function as an extension of each of the plurality of first public land mobile networks when providing wireless service to wireless devices that are associated with the respective first public land mobile network.

31. The wireless system of claim 30, wherein a wireless device is considered to be associated with a respective one of the plurality of first public land mobile networks if the wireless device is associated with a subscriber of the respective first public land mobile network or a subscriber of a public land mobile network that has a roaming agreement with the respective first public land mobile network.

32. The wireless system of claim 30, wherein the switching function and the register function are configured to provide wireless service to wireless devices associated with a plurality of second public land mobile networks, each of the plurality of second public land mobile networks having a roaming agreement with at least one of the plurality of first public land mobile networks; and
wherein the switching function and the register function are configured to function, when providing wireless service to wireless devices that are associated with each of the plurality of second public land mobile networks, as an extension of a respective one of the plurality of first public land mobile networks with which the respective second public land mobile network has a roaming agreement.

33. The wireless system of claim 30, wherein the register function is configured to determine if a first wireless device that is located within the coverage area associated with the wireless system is associated with a subscriber of one of the plurality of first public land mobile networks and, if the first wireless device is associated with a subscriber of one of the plurality of first public land mobile networks, the wireless system provides wireless service to the first wireless device as an extension of that first public land mobile networks.

34. The wireless system of claim 30, wherein the network switching subsystem is configured to, when providing wireless service as an extension of each of the plurality of first home public land mobile networks, use signaling addresses within a respective addressing scheme used in the respective first public land mobile network.

35. The wireless system of claim 30, wherein the network switching subsystem is configured to, when providing wireless service as an extension of each of the plurality of first home public land mobile networks, use global titles within a respective routing scheme used in the respective first public land mobile network.

36. The wireless system of claim 35, wherein the network switching subsystem further comprises a Signaling Connection Control Part (SCCP) function to perform global title translation using global titles within the respective routing scheme used in a respective first public land mobile network when the network switching subsystem is providing wireless service as an extension of the respective first public land mobile network.

37. The wireless system of claim 30, wherein the network switching subsystem is configured to, when providing wireless service as an extension of each of the plurality of first public land mobile networks, assigns temporary, allocate location independent telephone numbers from a respective range assigned by the respective first public land mobile network to the wireless system.

38. The wireless system of claim 30, wherein the network switching subsystem is configured to, when providing wireless service as an extension of each of the plurality of first public land mobile networks, route outgoing calls as specified for the respective public land mobile network.

39. The wireless system of claim 30, wherein the network switching subsystem is configured to, when providing wireless service as an extension of each of the plurality of first public land mobile networks, use location area codes within the location area code numbering scheme of the respective public land mobile network.

40. The wireless system of claim 30, wherein the network switching subsystem further comprises at least one of a home location register, an authentication center, and a prepaid service server, wherein the wireless system has local subscribers thereof.
